(19) United States
(12) Patent Application Publication
(10) Pub. No.: US 2007/0025399 A1
(43) Pub. Date: Feb. 1, 2007

(54) Method and apparatus for frequency and timing distribution through a packet-based network

(75) Inventor: Pierce V. Keating, Issaquah, WA (US)

Correspondence Address: VAN PELT, YI & JAMES LLP, 10050 N. FOOTHILL BLVD #200, CUPERTINO, CA, 95014, US

(73) Assignee: RadioFrame Networks, Inc.

(21) Appl. No.: 11/512,064

(22) Filed: Aug. 28, 2006

Related U.S. Application Data
(63) Continuation-in-part of application No. 10/132,086, filed on Apr. 24, 2002, now Pat. No. 7,099,354.
(60) Provisional application No. 60/351,921, filed on Jan. 24, 2002.

(51) Int. Cl. H04J 3/06

(52) U.S. Cl. 370/519

(57) ABSTRACT

A reference frequency is distributed through a packet-based network to remote elements in a system. Timing packets are sent from a master timing element, to be received by at least one peripheral timing element. Echo messages are sent to the master timing element by each peripheral timing element after a unique delay, in response to the reception of a timing packet. Loopback delay measurements are included in each timing packet for each peripheral timing element. Each peripheral timing element locks a loop using only timing packets which incur a minimum loopback delay

### CROSS REFERENCE TO RELATED APPLICATION

This application is a continuation-in-part of U.S. patent application Ser. No. 10/132,086, filed Apr. 24, 2002, entitled Method and Apparatus for Frequency and Timing Distribution through a Packet-based Network, now U.S. Pat. No. ______, which is hereby incorporated herein by reference in its entirety and which claimed the benefit of the filing date of provisional application serial Ser. No. 60/351,921 filed on Jan. 24, 2002, which provisional application also is hereby incorporated herein by reference in its entirety.

### FIELD OF INVENTION

This invention relates to the distribution of frequency and timing information over a packet-based network. The invention more particularly relates to apparatus and methods through which highly accurate frequency and phase synchronization can be achieved among various elements within a packet-based network using packets to distribute timing information.

### BACKGROUND OF THE INVENTION

For an electronic system which includes several elements interconnected through a packet-based network, such as Ethernet, and in which such elements are required to be closely synchronized in phase and frequency, it is difficult to construct means of synchronization. Many prior systems have required an alternative and substantially dedicated transmission medium, such as separate wires or a separate cable assembly, to transport a synchronization signal to the various system elements. Such prior alternative transmission mediums typically require substantial resources in addition to those of the packet-based network.

It is therefore an object of the present invention to provide a means through which elements of a system, which are interconnected through a packet-based network, can be accurately synchronized in phase and frequency relative to each other and to external references.

### SUMMARY OF THE INVENTION

A method and apparatus for frequency distribution through a packet-based network is provided. In accordance with one aspect of the invention, a method is provided for synchronization between a master timing element and at least one peripheral timing element interconnected through a packet-based network. According to the method, a timing packet is periodically transmitted from the master timing element according to a timing reference, where each peripheral timing element is coupled to receive the timing packets. After a timing packet is received by a peripheral timing element, an echo packet is transmitted to the master timing element from the same peripheral timing element. A loopback delay is then measured between the start of the transmission of the timing packet and the reception of a corresponding echo packet for each peripheral timing element. A plurality of loopback delay values corresponding to a peripheral timing element are read over time and the lowest loopback delay value for the peripheral timing element is designated as the nonblocked loopback delay for that peripheral timing element. Then, a loop is locked in each peripheral timing element using only timing packets which incur a nonblocked loopback delay for the corresponding peripheral timing element as a reference.

In accordance with another aspect of the invention, each echo packet is transmitted after a unique delay with respect to each peripheral timing element in order to reduce the likelihood of interblocking delays between echo packets.

In accordance with yet another aspect of the invention, a loop phase from a locked loop of each peripheral timing element is stored when a timing packet is received in each corresponding peripheral timing element. In addition, the loop phase minus the unique delay and minus one half the nonblocked loopback delay is designated as a phase reference for a peripheral timing element if the loop phase corresponds to a timing packet which incurred a nonblocked loopback delay value for the same peripheral timing element.

In accordance with still another aspect of the invention, a synchronous distributed system interconnected by a packet-based network is provided. The system includes a timing reference. Also included is a master timing element coupled to periodically transmit timing packets on the network according to the timing reference. Further included is at least one peripheral timing element coupled to receive the timing packets, each peripheral timing element being coupled to transmit an echo message on the network to the master timing element after a timing packet is received. Also included is a means to determine a loopback delay when each echo message is received by the master timing element, the loopback delay corresponding to each echo message included in a payload field of the following timing packet to be transmitted. Further included is a means to determine a minimum loopback delay corresponding to each peripheral timing element, one half of said minimum loopback delay representative of a nonblocked, network path delay from the master timing element to a peripheral timing element. Also included in each peripheral timing element is a locked loop which is coupled to lock using only timing packets which incur a minimum loopback delay.

In accordance with yet another aspect of the invention, as part of the system each peripheral timing element transmits an echo message after a unique delay.

In accordance with still another aspect of the invention, the system further includes means to designate a phase reference in each locked loop according to the reception of timing packets which incur a minimum loopback delay to a corresponding peripheral timing element minus one half of the minimum loopback delay.

In accordance with yet another aspect of the invention, the system is a distributed radio system, which includes at least one radio interface unit for wireless communication.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram of a distributed electronic system using Ethernet packets for system synchronization.

FIG. 2 is a depiction of fields included in a timing packet.

FIG. 3 is a flow chart, which depicts the synchronization method employed within a peripheral timing element.

FIG. 4 is a flow chart, which depicts the synchronization method employed within the master timing element.

FIG. 5 is a diagram of a distributed radio system using Ethernet packets for system synchronization.

FIG. 6 illustrates operation of a peripheral timing element in an embodiment in which the peripheral timing element is configured to request a timing packet.

FIG. 7 illustrates operation of a master timing element in an embodiment in which the peripheral timing element is configured to request a timing packet.

### DETAILED DESCRIPTION OF THE PREFERRED EMBODIMENT

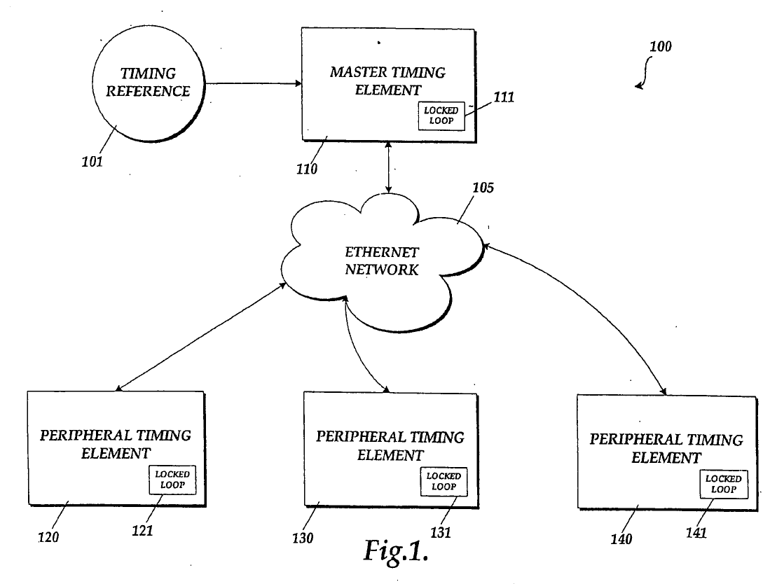

FIG. 1 is a diagram of a synchronous, frequency-locked distributed system (100) interconnected through a packet-based network. In many prior packet-based networks, an alternative and substantially dedicated transmission medium was required apart from the primary Ethernet network transmission medium in order to transport a synchronization signal to the various system elements. In order to reduce the cost of materials and to simplify the installation of such systems, and to maintain a commonly used Ethernet network interface standard within the system, the present invention interconnects the several elements only through standard Ethernet signaling using a minimum number of industry standard cable assemblies and interfaces to each system element. As will be described in more detail below, the present invention propagates timing and synchronization information to the system elements solely through the use of Ethernet packets.

The present invention addresses the issue of Ethernet packets being difficult to use for the purpose of timing and synchronization. The difficulty comes from the fact that these types of packets are subject to unpredictable constant and stochastic delays through an Ethernet network, which will significantly degrade the degree to which the various system elements can be accurately synchronized. For a time sensitive electronic system, such as a distributed radio system, in which several elements of the radio system are interconnected through an Ethernet network, the unpredictable delays of an Ethernet network interface would generally be intolerable for the purposes of system synchronization. This is particularly true if the synchronization signal is to be used as a time and frequency reference for slot and frame synchronization in a digital radio system or as a frequency reference for the synthesis of radio frequency (RF) carrier signals. As will be described in more detail below, the present invention addresses these issues.

As shown in FIG. 1, the synchronous distributed system (100) of the present invention is interconnected through a packet-based network (105). In general, a packet-based network does not guarantee a particular amount of bandwidth for the transmission of data. Instead, the transmission and reception of data is bursty in nature because elements interfaced to the network are allowed to transmit data at arbitrary, unsynchronized intervals. In operation, the elements of the system (110, 120, 130, and 140) are synchronized to each other in phase and frequency such that various tasks and functions allocated among the system elements (110, 120, 130, and 140) may be selectively executed in a substantially simultaneous manner or may be executed in a precise time sequence, relative to each other and also so that a frequency reference exists within each of the system elements (110, 120, 130, and 140), in which all of the frequency references are substantially frequency-locked. In this discussion, two or more frequencies are considered to be locked when they are related by a constant factor to the other frequencies.

The synchronous frequency-locked distributed system (100) includes one master timing element (110) and one or more peripheral timing elements (120, 130, and 140). In operation, the master timing element (110) in some embodiments transmits timing packets to peripheral timing elements (120, 130, and 140) in a periodic manner in accordance with a timing or frequency reference (101). In some embodiments, at the peripheral timing elements reference phase information is inferred from the periodicity with which timing packets are transmitted. In some alternative embodiments, the master timing element (110) transmits timing packets at pseudorandom intervals, as opposed to in a regular periodic manner, and includes a payload portion of each timing packet an explicit phase reference data, e.g., a time of transmission of the timing packet or a value read from a counter or other time/phase reference. While the present invention is not constrained to operate with any particular network standard, this discussion will generally refer to an Ethernet (105) as the network medium. However, it is to be understood that other network solutions, such as a wireless LAN, may be used to interconnect the elements of the system (110, 120, 130, and 140) without departing from the scope of the present invention. Preferably, the timing packets are transmitted to the peripheral timing elements (120, 130, and 140) as multicast or broadcast Ethernet packets. A timing packet transmitted from the master timing element (110) will be subject to a particular delay as the packet propagates to each of the peripheral timing elements (120, 130, and 140). The precise propagation delay of a timing packet will depend on the inherent or fixed delays associated with the network equipment with respect to a particular peripheral timing element (120, 130, or 140) and also will depend on the occurrence of “blocking” delays, in which the transmission of a timing packet is temporarily blocked while the transmission of another Ethernet packet is currently in progress. Consequently, the arrival time of a timing packet at any of the peripheral timing elements (120, 130, and 140) may be different and unpredictable.

When a timing packet is received by a particular peripheral timing element (120, 130, or 140), the peripheral timing element will respond with the transmission of an Ethernet echo message to the master timing element (110). Also included in the master timing element (110) is an echo timer (115) used to measure the elapsed time between the start of the transmission of a timing packet from the master timing element (110) and the receipt of an Ethernet echo message from any particular peripheral timing element (120, 130, or 140). The elapsed time described above is hereafter referred to as loopback delay.

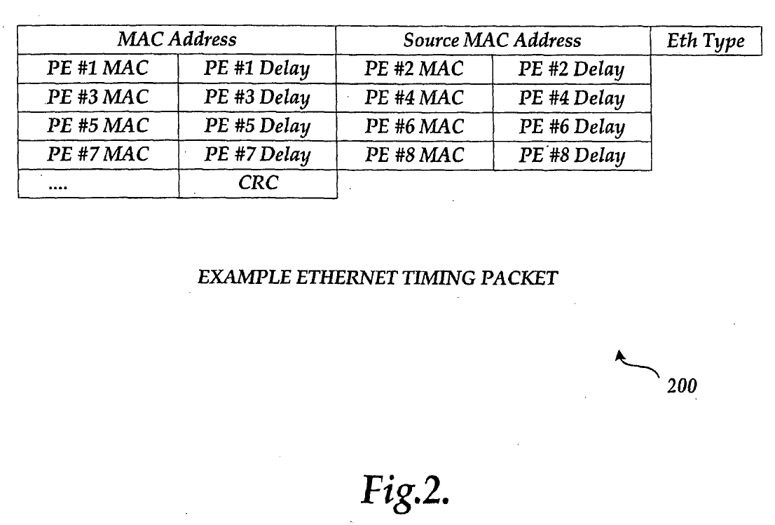

In the preferred embodiment of the present invention, each timing packet transmitted by the master timing element (110) includes one or more loopback delay values associated with the previous timing packet and corresponding echo messages from each peripheral timing element (120, 130, and 140). FIG. 2 illustrates how such information can be organized in a timing packet. The timing packet depicted in FIG. 2 includes a 48 byte destination media access control (MAC) address, a 48 byte source address, a 16 bit Ethernet type field and a 16 bit cyclic redundancy check (CRC) code as defined in the IEEE 803 Ethernet specification. The remaining field of the timing packet shown in FIG. 2 is commonly referred to as the payload. In FIG. 2, the payload includes the measured loopback delays associated with Ethernet echo messages received by the master timing element (110) from the peripheral timing elements (120, 130, and 140). The payload field depicted in FIG. 2 also includes peripheral address fields used to correlate a particular loopback delay value with a particular peripheral timing element (120, 130, and 140). The timing packet can incorporate either a broadcast, multicast, or unicast destination MAC address and can include loopback delay measurements for an arbitrary number of peripheral timing elements in the payload.

In operation, when a peripheral timing element (120, 130, or 140) receives a timing packet, the peripheral timing element (120, 130, or 140) will scan the payload field of the timing packet for a loopback delay measurement, which corresponds to that peripheral timing element (120, 130, or 140). For each timing packet received, a peripheral timing element (120, 130, or 140) will read the corresponding loopback delay measurement corresponding to the same peripheral timing element (120, 130, and 140) and will store the lowest loopback delay value detected over time. After a predetermined number of timing packets has been received by a peripheral timing element (120, 130, or 140), the minimum loopback delay value detected will be designated as twice the fixed or “nonblocked” Ethernet path delay from the master timing element (110) to the peripheral timing element (120, 130, or 140).

Each peripheral timing element (120, 130, and 140) further includes a locked loop (121, 131, and 141), such as a phase-locked loop (PLL) or a frequency-locked loop (FLL), both of which are well known in the art. While a PLL is used as an example in this discussion, it is to be understood that the scope of the present invention includes both a PLL and an FLL. In operation, the locked loop (121, 131, and 141) included in each peripheral timing element (120, 130, and 140 respectively) is phase-locked to timing packets.

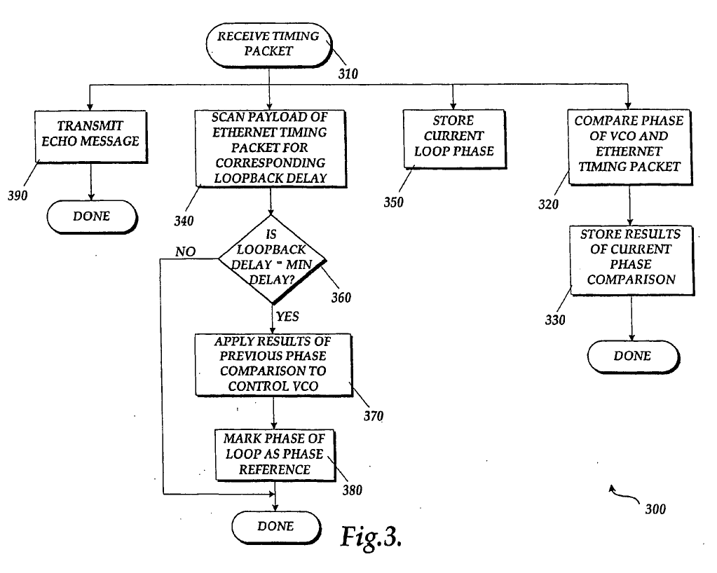

Each PLL (121, 131, and 141) includes a phase detector and a voltage controlled oscillator (VCO). Operation of each PLL (121, 131, and 141), in conjunction with a timing packet reference, is depicted in the flow chart in FIG. 3. As shown in FIG. 3, block (310) corresponds to an event in which a timing packet is received by a peripheral timing element (120, 130, or 140). After a timing packet is received, the phase detector in the corresponding PLL (121, 131, or 141) will compare the phase of each received timing packet with the phase of the VCO as indicated at block (320), and the peripheral timing element (120, 130, or 140) will examine the payload for a corresponding loopback delay measurement as indicated in block (340) and will transmit an echo message to the master timing element (110) as indicated in block (390). A following step, as indicated at block (330), stores the result of the phase comparison. A decision step, indicated at block (360) checks if the loopback delay is substantially equivalent to the minimum loopback delay. If the loopback delay is substantially equivalent to the minimum loopback delay, then the stored results of the previous phase comparison will be applied to control the frequency of the VCO as required to achieve or retain a locked condition with respect to the timing packet, as depicted at block (370). Using the method depicted in flow chart (300), the PLL included in each peripheral timing element (120, 130, or 140) will be phase-locked only to timing packets which are associated with nonblocked Ethernet path delays, as discerned by the detection of corresponding nonblocked or minimum value loopback delays embedded in the timing packets.

In FIG. 3, the reception of a timing packet triggers the execution of four task flow paths. Preferably the transmit echo message function (390) and the phase comparison function (320) are executed simultaneously when a timing packet is received or are executed after a timing packet is received with respect to predictable and relatively constant delays.

Each PLL or locked loop (121, 131, and 141) has a loop phase. If the PLL (121, 131, or 141) includes a loop divider, then the phase of the loop divider and VCO together represent the loop phase. If the PLL (121, 131, or 141) does not include a loop divider, then the VCO phase alone represents the loop phase. If the PLL (121, 131, or 141) includes a loop divider having a relatively large value, then the phase of the loop divider is a close approximation of the loop phase. Some distributed systems require a phase reference that is substantially constant among the peripheral timing elements (120, 130, and 140). In order to establish a constant phase reference among the peripheral timing elements, the loop phase of each PLL (121, 131, and 141) is selectively marked or designated as a phase reference in conjunction with the arrival of timing packets with a minimum loopback delay. In operation, the current phase of a PLL (121, 131, or 141) is stored when each timing packet is received by a corresponding peripheral timing element (120, 130, or 140) as shown at block (350) in FIG. 3. After a loopback delay value is found in the payload of a timing packet, which corresponds to the receiving peripheral timing element (120, 130, or 140) and which is substantially equal to the nonblocked network path delay, then the previously stored phase value is used to set or designate a phase reference as shown at block (380). For example, if it were desired that a peripheral timing element (120, 130, or 140) have a phase reference that is coincident with the phase of the timing reference (111), then the phase reference would be designated as a previously stored phase value, which corresponds to a timing packet with a minimum loopback delay, minus half the minimum loopback delay. If the PLL is a type 2 control loop, the loop phase will be aligned with arrival of non-blocked timing packets. For this case, the phase reference would be the loop phase minus half the minimum loopback delay. Thus, the synchronization method described above provides an accurate distributed phase reference over a network, which compensates for the arbitrary nonblocked network path delay of the timing packets. Further, each PLL (121, and 141) will maintain the distributed phase reference, in the present blocking delays, due to memory which is inherent in each PLL (121, 131, and 141).

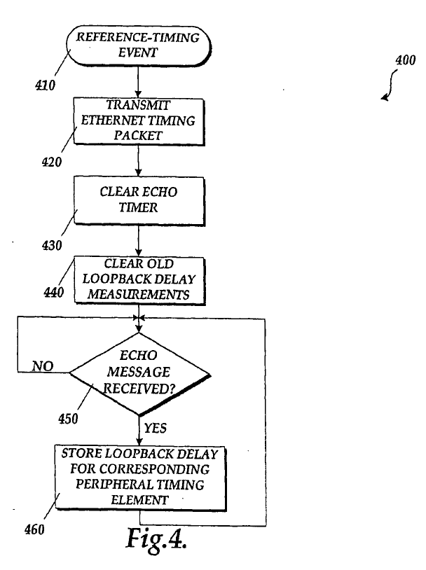

An example task flow for the transmission of timing packets by a master timing element (110) is shown in FIG. 4. In FIG. 4, the occurrence of a reference-timing event, shown at block (410), triggers the transmission of a timing packet and clears the echo timer and previous loopback delay measurements, shown at blocks (420, 430 and 440) respectively. The master timing element (110) will then look for received echo messages as shown at block (450). As shown at block (460), when an echo message is received from a peripheral timing element (120, 130, or 140), the master timing element (110) will use the current value of the echo timer to calculate a loopback delay, and will store the loopback delay to correspond with the associated peripheral timing element (120, 130, or 140). Each stored loopback delay is included in the payload of the following timing packet transmitted by the master timing element (110).

When a plurality of peripheral timing elements (120, 130, and 140) each receive a timing packet simultaneously, a plurality of echo messages may be transmitted to the master timing element (110) substantially simultaneously. In this condition, some echo messages may incur interblocking delays when received at the master timing element (110) due to the simultaneous arrival of other echo messages. In order to reduce the likelihood of echo messages blocking each other, each peripheral timing element is set to delay the transmission of an echo message, in response to the reception of a timing packet, by a unique time interval. In a preferred embodiment of the present invention, when a peripheral timing element (120, 130, or 140) first receives a timing packet, the peripheral timing element (120, 130, or 140) will immediately transmit an echo message to the master timing element (110). When a peripheral timing element (120, 130, or 140) receives subsequent timing packets, the peripheral timing element (120, 130, or 140) will note the sequence number in which a corresponding loopback delay is positioned within the payload of the timing packet and will delay the transmission of an echo message according to the sequence number. The peripheral timing element (120, 130, and 140) will subtract the added unique delay of the echo message in the corresponding loopback delay when setting the phase reference. Thus, each peripheral timing element (120, 130, and 140) will transmit an echo message, in response to a received timing packet, after a unique interval in time, thereby minimizing the occurrence of blocking delays among the echo messages.

The master timing element (110) includes a delay reference frequency used to measure the loopback delays associated with peripheral elements (120, 130, and 140). In the preferred embodiment, each locked-loop (121, 131, and 141) is configured to generate a local frequency equal to the delay reference frequency. In operation, each timing packet is sent as an Ethernet broadcast or multicast message from the master timing element (110) to the peripheral timing elements (121, 131, and 141 respectively) at a frequency which is lower than and derived from the frequency of the timing reference (101). Alternatively, the master timing element (110) may include a master locked loop (111) used to lock to a timing reference (101) having a relatively low frequency. The master locked loop (111) includes a loop divider in order to multiply the frequency of the timing reference (101) to a relatively higher delay reference frequency. Preferably the transmission of timing packets from the master timing element (110) is triggered from the timing reference (101). When a peripheral timing element (120, 130, or 140) receives a timing packet, the peripheral timing element (120, 130, or 140) sends an echo message to the master timing element (110) after a unique delay, which is derived according to the local frequency in the peripheral timing element (120, 130, or 140). Each timing packet includes a loopback delay value, as measured in accordance with the delay reference frequency in the master timing element (110), corresponding to each echo message received from the peripheral timing elements (120, 130, and 140). When a peripheral timing element (120, 130, or 140) receives a timing packet, it retrieves the associated loopback delay value from the payload and subtracts the respective unique delay value in order to determine the network loopback delay.

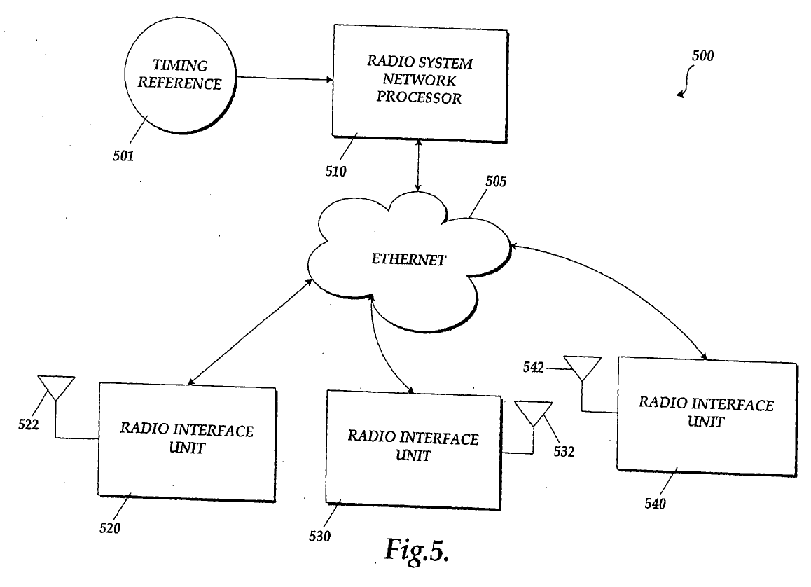

Referring to FIG. 5, a distributed radio system (500) includes multiple system components interconnected through an Ethernet network (505). The distributed radio system (500) includes at least one radio interface unit (520, 530, or 540), which includes means for wireless communication. The radio system network processor (510) is coupled to send control information to the radio interface units (520, 530, and 540) as well as data to be transmitted by the radio interface units (520, 530, and 540) and to accept data received by the radio interface units (520, 530, and 540). In operation, each radio interface unit (520, 530, and 540) generates at least one carrier signal in accordance with the timing reference (501). An accurate estimate of the phase and frequency of the timing reference (501) is generated within each radio interface unit (520, 530, and 540) through the use of Ethernet timing packets transmitted by the radio system network processor (510) using the packet timing synchronization method described above, where the radio system network processor (510) includes equivalent master timing element (110) functionality and where the radio interface units (520, 530, and 540) include equivalent peripheral timing element (120, 130, and 140) functionality. Each radio interface unit (520, 530, and 540) further includes a phase reference, which is synchronized relative to a phase reference within the radio system processor (510) through the use of the Ethernet timing packets using the method described herein.

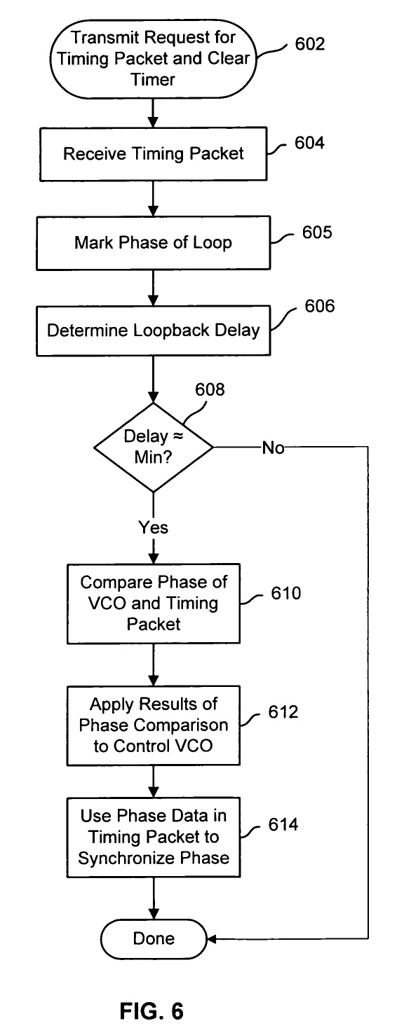

FIG. 6 illustrates operation of a peripheral timing element in an embodiment in which the peripheral timing element is configured to request a timing packet. A request for a timing packet is sent, and a loopback delay timer cleared/reset (602). In some embodiments, a request for a timing packet is sent in response to a determination, e.g., at the peripheral timing element, that a PLL and/or FLL requires an updated reference, e.g., due to passage of time, a report of a problem or error potentially attributable to lack of synchronization, etc. The requested timing packet is received (604). A phase of a local loop (e.g., PLL) at the time of receipt of the timing packet is noted (605). In some embodiments, the phase is noted by reading a counter upon receipt of the timing packet and storing the value read from the counter. A loopback delay is determined (606). In some embodiments, the loopback delay is determined by stopping, upon receipt of the requested timing packet, the loopback delay timer cleared when the request for the timing packet was sent (602) and reading the elapsed time recorded by the timer. If the determined loopback delay associated with the received timing packet deviates from an expected minimum (nonblocked) loopback delay by more than a prescribed amount (608), the timing packet is discarded and the process of FIG. 6 ends. If the determined loopback delay associated with the received timing packet does not deviate from a minimum loopback delay by more than a prescribed amount (608), the phase of a voltage controlled oscillator is compared to the timing packet (610); the result of the comparison is applied to the VCO as phase error feedback (612). In addition, the phase of the local loop marked upon receipt of the timing packet (605) and a phase data included in a payload portion of the timing packet are used to synchronize the local loop phase with a reference phase (614), after which the process of FIG. 6 ends. In some embodiments, a master timing element from which the timing packet was requested (602) includes in the payload portion of the timing packet an explicit phase data, such as a time at which the timing packet was sent in response to the request. In some such embodiments, 614 includes using the phase data included in the timing packet, the local loop phase marked upon receipt of the timing packet, and the minimum loopback delay to synchronize the phase of the local loop with that of the master timing element. In some embodiments, the synchronization includes adding one half the minimum loopback delay to the phase data included in the timing packet and comparing the result to the local phase marked at 605. For example, and using exaggerated numbers to provide a mathematically simple example, if the timing packet indicated it was sent at 13:05:10 (i.e., 10 seconds after 1:05 pm) and the minimum loopback delay were 2 seconds, the expected local time at receipt under perfectly synchronized conditions would be 13:05:12. If in the preceding example the local phase (in this example time) noted at 605 were 13:05:15, it would be concluded at 614 that the local time (phase) was ahead of the reference (master) by 3 seconds and the local phase would be adjusted (synchronized) accordingly.

Using minimum loopback delay measurements as a qualifier as to whether a particular timing packet is used or ignored as a potential phase reference for the PLL and for determining a substantially synchronous phase or time reference at the client with respect to the master timing element, provides a type of jitter filtering associated with dynamic events such as blocking delays. Consequently, the PLL need not be designed to “filter” the jitter, since it will not be allowed into the loop. Also, by only using phase information associated with substantially minimum loopback delays, phase or time synchronization of the client with respect to the master timing element can be considered highly accurate. Consequently, synchronization can occur substantially instantaneously with the reception of the timing packet having a minimum loopback delay, with little need for filtering or averaging. That is, if a timing packet is received by a client with a minimum loopback delay and the timing packet also includes information that the time was N hours and Y seconds when the packet was sent, then the client can accurately and instantaneously presume that it is synchronized with the master timing element if its own phase reference or clock would be N hours and Y seconds minus one half of the computed loopback delay when the timing packet was received by the client.

In some embodiments, the peripheral timing element is configured to determine the nonblocked loopback delay by noting the loopback delay associated with successive received timing packets and designating a minimum loopback delay as the nonblocked loopback delay. In some embodiments, the nonblocked loopback delay is updated to equal the loopback delay associated with a most recently received timing packet if the loopback delay associated with the most recently received timing packet is less than the currently stored nonblocked loopback delay and a timing packet corresponding to the currently stored nonblocked loopback delay, prior to updating, has not been received within a prescribed period of time. In some embodiments, a master timing element is configured to update the nonblocked loopback delay associated with a peripheral timing element if an observed loopback delay associated with the peripheral timing element is less than a currently stored nonblocked loopback delay associated with that peripheral timing element and a timing packet having an observed loopback delay corresponding to the currently stored nonblocked loopback delay, prior to updating, has not been received within a prescribed period of time.

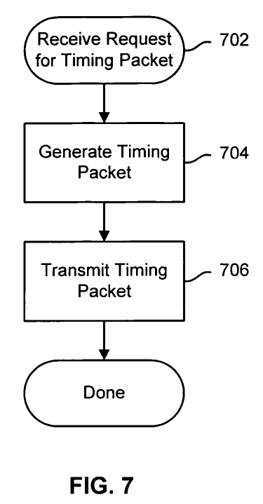

FIG. 7 illustrates operation of a master timing element in an embodiment in which the peripheral timing element is configured to request a timing packet. A request for a timing packet is received (702). A timing packet is generated (704) and transmitted to the requestor (706). In some embodiments, as noted above, the timing packet generated at 704 includes a phase reference, such as a time of transmission, a counter value (e.g., a counter that counts to a prescribed maximum value then rolls back to zero), etc.

The present invention enables a plurality of elements, interconnected through a packet-based network, to be accurately synchronized in phase and frequency through the use of periodic timing packets, which are used as a phase and frequency reference for a locked loop. In general, this is accomplished by first measuring a nonblocked loopback path delay and then using only periodic timing packets which incur the nonblocked loopback path delay as a frequency and phase reference. While the preceding description of the present invention has grouped certain functions into either the peripheral timing elements or the master timing element, one skilled in the art will recognize that many other combinations or groupings are possible. Numerous modifications, changes, variations, substitutions, and equivalents will occur to those skilled in the art without departing from the spirit and scope of the present invention as defined by the appended claims.

The embodiments of the invention in which an exclusive property or privilege is claimed are defined as follows:

1. A method of frequency and timing distribution through a packet-based network, comprising:
transmitting a timing packet via the packet-based network according to a timing reference;
receiving an echo packet sent by a peripheral timing element in response to receiving the timing packet;
measuring a loopback delay between the start of the transmission of the timing packet and the reception of the echo packet; and
reporting the loopback delay to the peripheral timing element.

2. The method of claim 1, wherein reporting the loopback delay to the peripheral timing element comprises including the loopback delay in a second timing packet transmitted via the packet-based network according to the timing reference subsequent to receipt of the echo packet.

3. The method of claim 2, further comprising including in the second timing packet an identifier that associates the loopback delay with the peripheral element.

4. The method of claim 1, further comprising receiving the timing packet at the peripheral device; and sending the echo packet from the peripheral device via the packet-based network in response to receiving the timing packet.

5. The method of claim 1, wherein the timing packet comprises one of a plurality of timing packets, each having a corresponding loopback delay associated with it, and the method further comprises designating as a nonblocked loopback delay a lowest loopback delay value among the respective corresponding loopback delays associated with the plurality of timing packets.

6. The method of claim 5, wherein the nonblocked loopback delay represents the round trip delay associated with sending a packet from a sending node from which the timing packet is transmitted to the peripheral timing element and receiving from the peripheral timing element a responsive packet sent in response to the packet, via the packet-based network, under conditions in which transmission of the packet via the packet-based network is not delayed due to congestion on the packet-based network due to other packets being transmitted via the packet-based network at the same time as one or both of the packet and the responsive packet.

7. The method of claim 1, further comprising:
receiving the loopback delay at the peripheral device;
determining whether the loopback delay satisfies a criterion that is based at least in part on a nonblocked loopback delay; and
in the event it is determined that the loopback delay satisfies the criterion, using the timing packet as a reference to lock a loop associated with the peripheral timing element based at least in part on the determination that the loopback delay satisfies the criterion.

8. The method of claim 7, further comprising not using the timing packet to lock the loop in the event it is determined that the loopback delay does not satisfy the criterion.

9. The method of claim 7, further comprising determining the nonblocked loopback delay.

10. The method of claim 9, wherein the timing packet comprises one of a plurality of timing packets, each having a corresponding loopback delay associated with it, and the method further comprises designating as the nonblocked loopback delay a lowest loopback delay value among the respective corresponding loopback delays associated with the plurality of timing packets.

11. The method of claim 10, wherein the peripheral timing element is included in a plurality of peripheral timing elements configured to receive the plurality of timing packets and each peripheral timing element comprising the plurality of peripheral timing elements is configured to designate as a respective nonblocked loopback delay for that peripheral timing element a corresponding lowest loopback delay value among the respective corresponding loopback delays associated with the plurality of timing packets as received by that peripheral timing element and to use only those timing packets that satisfy the criterion with respect to the respective nonblocked loopback delay for that peripheral timing element as a reference to lock a respective loop associated with that peripheral timing element.

12. The method of claim 7, wherein the criterion requires that the loopback delay be equal to the nonblocked loopback delay.

13. The method of claim 7, wherein the criterion requires that the loopback delay not be less than or greater than the nonblocked loopback delay by more than a prescribed amount.

14. The method of claim 7, further comprising updating the nonblocked loopback delay to equal the loopback delay if the loopback delay is less than the nonblocked loopback delay and a timing packet corresponding to the nonblocked loopback delay, prior to updating, has not been received within a prescribed period of time.

15. The method of claim 1, wherein the peripheral timing element is included in a plurality of peripheral timing elements configured to receive the plurality of timing packets and each peripheral timing element is configured to transmit a respective each echo packet after a unique delay associated with that peripheral timing element in order to reduce the likelihood of interblocking delays between echo packets.

16. The method of claim 15, wherein each peripheral timing element is configured to store a respective loop phase from a respective locked loop associated with that peripheral timing element upon receipt of each timing packet; and designate as a phase reference for that peripheral timing element the loop phase minus said unique delay and minus one half a nonblocked loopback delay of the peripheral timing element if the loop phase corresponds to a timing packet that satisfied a criterion that is based at least in part on said nonblocked loopback delay.

17. The method of claim 1, wherein the peripheral timing element is configured to store a loop phase from a locked loop associated with the peripheral timing element upon receipt of the timing packet; and designate as a phase reference the loop phase minus at least one half a nonblocked loopback delay of the peripheral timing element if the timing packet satisfies a criterion that is based at least in part on said nonblocked loopback delay.

18. A synchronous, frequency-locked distributed system interconnected by a packet-based network comprising:
a timing reference; and
a master timing element configured to transmit timing packets on the network according to the timing reference; receive an echo packet sent by a peripheral timing element in response to receiving the timing packet; measure a loopback delay between the start of the transmission of the timing packet and the reception of the echo packet; and report the loopback delay to the peripheral timing element.

19. A synchronous, frequency-locked distributed system as recited in claim 18 wherein the peripheral timing element includes a locked loop.

20. A synchronous, frequency-locked distributed system as recited in claim 18, wherein the master timing element is configured to include the loopback delay in a payload field of a following timing packet to be transmitted.

21. A synchronous, frequency-locked distributed system as recited in claim 18, wherein the peripheral timing element is configured to determine a minimum loopback delay, one half of said minimum loopback delay being representative of a nonblocked network path delay from the master timing element to the peripheral timing element.

22. A synchronous, frequency-locked distributed system as recited in claim 21, wherein the locked loop is coupled to lock using only timing packets that satisfy a criterion that is based at least in part on said minimum loopback delay.

23. The synchronous, frequency-locked distributed system as recited in claim 18 wherein the peripheral timing element comprises one of a plurality of peripheral timing elements and each peripheral timing element included in the plurality transmits an echo message after a unique delay.

24. The synchronous, frequency-locked distributed system of claim 18, wherein the system comprises a distributed radio system, which includes at least one radio interface unit for wireless communication.

25. A method of frequency and timing distribution through a packet-based network, comprising:
receiving a timing packet sent via the packet-based network;
determining whether a loopback delay associated with the timing packet satisfies a criterion that is based at least in part on a nonblocked loopback delay; and
in the event it is determined that the loopback delay satisfies the criterion, using the timing packet as a reference to lock a loop associated with the peripheral timing element based at least in part on the determination that the loopback delay satisfies the criterion.

26. The method of claim 25, further comprising requesting that the timing packet be sent.

27. The method of claim 26, wherein the request that the timing packet be sent is sent via the packet-based network.

28. The method of claim 27, wherein the loopback delay comprises the time between a start time when the request was sent and an end time when the timing packet was received.

29. The method of claim 26, wherein the request that the timing packet be sent is sent in response to a determination that an updated reference is needed for the loop.

30. The method of claim 25, further comprising determining the unblocked loopback delay.

31. The method of claim 30, wherein the timing packet comprises one of a plurality of timing packets that have been received by a peripheral timing element, each having a corresponding loopback delay associated with it, and determining the unblocked loopback delay comprises designating as the unblocked loopback delay for the peripheral timing element a lowest loopback delay value among the respective corresponding loopback delays associated with the plurality of timing packets.

32. The method of claim 25, further comprising storing a loop phase from a locked loop upon receipt of the timing packet; and designating as a phase reference, in the event it is determined that the loopback delay satisfies the criterion, the loop phase minus at least one half the nonblocked loopback delay.

33. The method of claim 25, wherein the timing packet comprises phase information.

34. The method of claim 33, wherein the phase information is implied by a periodicity of transmission of a series of timing packets comprising the timing packet.

35. The method of claim 33, wherein the phase information comprises data included in a payload of the timing packet.

36. The method of claim 33, wherein the phase information comprises a current time of a master timing element that sent the timing packet at a time of transmission of the timing packet.

37. A peripheral timing element of a synchronous distributed system interconnected by a packet-based network, the peripheral timing element comprising:
a communication interface configured to receive a timing packet sent via the packet-based network; and
a logic circuit configured to determine whether a loopback delay associated with the timing packet satisfies a criterion that is based at least in part on a nonblocked loopback delay;
and in the event it is determined that the loopback delay satisfies the criterion, use the timing packet as a reference to lock a loop associated with the peripheral timing element based at least in part on the determination that the loopback delay satisfies the criterion.

38. The peripheral timing element of claim 33, wherein the processor is further configured to use the communication interface to send via the packet-based network a request that the timing packet be sent.
